(19) United States
(12) Patent Application Publication
(10) Pub. No.: US 2006/0000773 A1
(43) Pub. Date: Jan. 5, 2006

(54) Process for the synthesis of a chromatographic phase

(76) Inventors: Jeremy Glennon, Carrigaline (IE); Liam Healy, Cork (IE)

Correspondence Address: JACOBSON HOLMAN PLLC, 400 SEVENTH STREET N.W., SUITE 600, WASHINGTON, DC, 20004, US

(21) Appl. No.: 11/218,586

(22) Filed: Sep. 6, 2005

Related U.S. Application Data
(63) Continuation of application No. PCT/IE04/00030, filed on Mar. 5, 2004.

(30) Foreign Application Priority Data
Mar. 7, 2003 (IE) 2003/0168

(51) Int. Cl. B01D 15/08

(52) U.S. Cl. 210/635; 210/656; 436/161

(57) ABSTRACT

A process for the synthesis, delivery or deposition or localisation of a chromatographic phase, especially for chromatographic separation or solid phase extraction, comprises introducing a chemical moiety to a support using a supercritical fluid such as supercritical carbon dioxide.

The invention relates to a process for synthesising a chromatographic phase, in particular a chromatographic stationary phase, and the products thereof.

### BACKGROUND OF THE INVENTION

Most known chromatographic stationary phases today comprise two distinct parts, the support and the ligand. Supports used include silica (1-3), alumina (4), polystyrene-divinylbenzene (PS-BVB) (5) and porous graphitic carbon (PGC) (6). Of these, silica is the most widely used due to the relative ease with which it can be modified (7). A wide range of ligands have been successfully immobilised on'these supports. They range from straight chain hydrocarbons, of which C₈ and C₁₈ chain lengths are the most popular (8), to complex macrocycles such as cyclodextrins (9-12), calixarenes (13-15) and antibiotics (16). The usual manner in which these phases are synthesised is to introduce a reactive form of the ligand to the support, thereby forming covalent bonds to ensure a stable structure. The ligand is taken to mean the chemical entity that is attached to the silica surface.

The reactions of alkoxysilanes and chlorosilanes with silica are well known (17-19). These processes have been extensively studied and account for most of the production of chromatographic stationary phases (7). One method of synthesis involves passing a gaseous stream of an organosilane at high temperatures (>300° C.) over the silica (20). The chlorine atom or the alkoxy group (X) reacts with the surface hydroxyl group on the metal oxide leaving the organo group extending from the surface according to the following equation in which Si₍₅₎ denotes a surface silicon atom.
Si₍₅₎OH+X₄₋ₙSiRₙ→Si₍₅₎OSiRₙX₃₋ₙ+HX

Alternatively if a non-volatile organosilane is employed, it may be reacted with the metal oxide in a nonaqueous liquid solution below 100° C. (21). The organosilane reacts with trace amounts of water (present either on the silica or in the solution) to form an organosilanol which, in turn, reacts with the surface silanol groups in accordance with die following equations, using a chloro-organosilane as an example (22).
RₙSiCl₄₋ₙ+(4−n)H₂O→RₙSi(OH)₄₋ₙ+(4−n)HCl
Si₍₅₎OH+RₙSi(OH)₄₋ₙ+Si₍₅₎O—Si(OH)₃₋ₙRₙ+H₂O

In recent years, silica hydrides have attracted considerable attention as intermediates in the preparation of chromatographic stationary phases via a silanisation/hydrosilation protocol [23,24] Methodology has been developed to produce reproducible surfaces with high hydride loadings [25]. These can then be further functionalised by derivatisation with alkenes [26], alkynes [27], or carbonyls [28].

A variety of chiral selectors have been bonded to supports for enantiomeric separations. For example, quinine has been frequently used as a chiral resolving agent [29,30] and, in chromatography, as a chiral selector [29] or additive [30]. Currently, chiral ion-exchange columns containing a quinine selector are commercially available [29] as ProntoSIL Chiral AX QN-1 for the resolution of acidic chiral compounds such as N-derivatised amino acids, amino sulfonic acids, and amino phosphonic acids. These phases are generally produced in organic solvents via Michael addition of 3-mercaptopropyl-modified silica to the pendant vinyl group most commonly using AIBN as a free radical initiator. 3-mercaptopropyl silica has been widely used as an easily prepared functionalised silica surface, to which selectors of interest may be conveniently tethered. This approach has been used by several workers particularly by Lindner and co-workers [31-44].

Silica-based phases experience difficulties with residual surface silanols interacting with analytes [45]. This is especially pronounced for basic compounds [46]. To overcome this problem, a phase is end-capped after the ligand is attached [47]. This is a silylation process which uses a silylating agent such as trimethylchlorosilane or hexamethyldisilizane to react with these surface silanols, thereby inhibiting unwanted attractions to analytes.

Yarita et al employed supercritical CO₂ as a reaction medium to end-cap an octadecasilica (ODS) chromatographic stationary phase prepared by conventional methods [48].

U.S. Pat. No. 5,725,987 and U.S. Pat. No. 5,714,299 both in the name of Xerox Corporation describe a process for the preparation of toner additives for the photocopying industry. Supercritical and liquid carbon dioxide are used as alternative media for the reaction of functionalised silanes and silicas [49-51].

Shin et al have used supercritical CO₂ to modify a commercial zeolite with mercaptopropyl silane [52].

Liquid chromatography is the most widely used technique for chemical analysis and the market continues to grow at a rate of 6% per annum. Current techniques used for synthesising chromatographic phases are complex and time consuming.

There is therefore a need for improved, high efficiency preparative chromatographic phases and sample preparation phases such as for solid phase extraction. There is also a need for more efficient and higher purity inert stationary phases to discriminate between and analyse large numbers of solutes in a single run.

### STATEMENTS OF INVENTION

According to the invention there is provided a process for the synthesis, delivery or deposition of a chromatographic phase, especially for chromatographic separation or solid phase extraction, comprising introducing a chemical moiety to a support using a supercritical fluid.

Preferably the support is a porous solid metal oxide. Most preferably the porous solid metal oxide is nanoporous, mesoporous, microporous or macroporous.

In one embodiment of the invention the support is in the form of a particle, sol gel, monolith, aerogel, xerogel, membrane, fibre or a surface, such as of a capillary, micro/nano-channel or microfabricated column on-chip.

In one embodiment of the invention the support is in the form of a non-porous particle, a hollow shell, a nanoshell or nanotube.

Preferably the metal oxide is selected from any one or more of silica, alumina, titania or a functionalised metal oxide such as aminopropylsilica or hydride silica.

In one embodiment of the invention a reactive form of the chemical moiety is delivered to the support by the supercritical fluid.

The chemical moiety may be deposited onto the support phase.

In one embodiment of the invention the chemical moiety is soluble in the supercritical fluid.

Preferably the chemical moiety is a reactive organosilane such as an alkoxy derivative, a halogenated derivative or hydrosilane.

Most preferably the chemical moiety is selected from any one or more of dimethylmethoxyoctadecylsilane or trichloro-octylsilane.

The chemical moiety may also be selected from any one or more of n-octadecyltriethoxysilane or n-octadecyl-dimethyl-monomethoxysilane, 1H, 1H, 2H, 2H-perfluorooctyltriethoxysilane, hexamethyldisilazane or trimethyl-chlorosilane, or reagents such as alkene derivatives and alkyne derivatives for the process of hydrosilation with a silica hydride.

Preferably the chemical moiety is octadecyldimethylchlorosilane or octadecyldimethylmethoxysilane.

In one embodiment of the invention attachment or deposition of the chemical moiety to the support yields a hydrocarbon chromatographic phase, a fluorinated hydrocarbon chromatographic phase, a perfluorinated chromatographic phase, a reversed phase chromatographic phase, a normal phase chromatographic phase, an ion exchange chromatographic phase, an affinity chromatographic phase, a chiral chromatographic phase, a chelating phase, a macrocyclic phase (such as a calixarene phase) or a silica hydride phase.

In another embodiment of the invention the hydrocarbon phase is a C8 or C18 phase.

In a preferred embodiment of the invention the supercritical fluid is supercritical carbon dioxide.

Most preferably the reaction is carried at a temperature of from 31.2° C. to 600° C.

The reaction may also be carried at a temperature of from 40° C. to 80° C.

In one embodiment of the invention the reaction is carried out at a pressure of from 1,058 psi (72.9 atm) to 30,000 psi (2,040.8 atm), preferably from 1,200 psi to 8,000 psi. Preferably the reaction is carried out for a period of up to 100 hours, most preferably approximately 3 hours.

In one embodiment of the invention the process includes a chelating agent Preferably the chelating agent is a metal sequestering agent and is selected from a fluorinated or non-fluorinated hydroxamic acid. The metal sequestering agent may be perfluorooctylhydroxamic acid (PFOHA) or N-methylheptafluorobutyric hydroxamic acid (MHFBHA)

The invention also provides a process for synthesising a chromatographic phase comprising the steps of;
adding a support and a chemical moiety to a reaction vessel;
delivering a reaction medium such as CO₂ to the reaction vessel;
raising the temperature of the reaction vessel to a temperature of between 30° C. to 600° C. at a pressure of between 1,000 psi to 30,000 psi to form a supercritical fluid;
agitating the contents of the reaction vessel for approximately 3 hours; and
recovering the chromatographic phase.

One embodiment of the invention includes the step of modifying the chromatographic phase using a chelating agent, pre-, in-, or post-process.

In another embodiment of the invention the reaction is carried out in a single chamber.

In another embodiment of the invention is included the step of drying the silica with the supercritical fluid in the chamber.

The invention provides a process for the synthesis of a chromatographic phase comprising introducing a chemical moiety to a support in the presence of a supercritical solvent and a chelating agent. Preferably the chelating agent is a metal sequestering agent such as a fluorinated or non-fluorinated hydroxamic acid. Most preferably the metal sequestering agent is perfluoro-octylhydroxamic acid (PFOHA) or N-methylheptafluorobutyric hydroxamic acid (MHFBHA)

The invention also provides a chromatographic phase whenever prepared by a process of the invention.

The invention further provides bonded silica phases for chromatographic or solid phase extraction purposes whenever prepared by a process of the invention.

In another aspect the invention provides a stationary phase having Si—OMe surface species.

In a further aspect the invention provides a chromatographic stationary phase having a chelating agent on the surface thereof.

The invention also describes the use of a supercritical fluid in the preparation of a chromatographic phase such as a bonded silica phase.

### BRIEF DESCRIPTION OF THE DRAWING

The invention will be more clearly understood from the following description thereof given by way of example only with reference to the accompanying drawings in which:—

FIG. 1 shows a ²⁹Si solid state NMR of a sc-fluorinated C₈ phase; A diagram of the phase is given at the top. Known silicon resonances are quoted at the side;

FIG. 2 shows a ¹³C solid state NMR of a sc-fluorinated C₈ phase;

FIG. 3 shows a ²⁹Si solid state NMR of a sc-C₁₈ phase. A diagram of the phase is given at the top. Known silicon resonances are quoted at the side;

FIG. 4 shows a ¹³C CP/MAS solid state NMR spectrum of a sc-C₁₈ phase. Known carbon resonances are given on the left hand side with the experimental spectrum and resonances on the right;

FIG. 5 is a chromatogram showing a test mix elution on a non-endcapped sc-C₁₈ column (100 mm×4.6 mm i.d, 3 m particles). Mobile phase used was 50% acetonitrile (v/v) pumped at a flow rate of 1.00 ml/min. Column efficiency of 141,000 theoretical plates per metre is surprising, given that the phase has not been end-capped.

FIG. 6 is a chromatogram showing an elution of N,N-DMA and toluene on an sc-end-capped sc-C₁₈ phase. The order of elution indicates reduced silanol activity according to the Engelhardt test;

FIG. 7 is a chromatogram showing an elution of para-, meta- and ortho-toluidine on an sc-endcapped sc-C₁₈ phase. The co-elution of the three compounds indicates reduced silanol activity, according to the Engelhardt test;

FIG. 8 is a chromatogram showing elution of four β-blockers on an sc-endcapped sc-C₁₈ column (100 mm×4.6 mm i.d, 3 m particles). Mobile phase used was MeOH/KH₂PO₄ buffer at pH 4, flow rate of 1.00 ml/min.; Proterenol, tᵣ=1.192 min., pronethalol, tᵣ=5.706 min.; labetalol, tᵣ=8.070 min.; propranolol, tᵣ=11.968 min; and

FIG. 9 is a chromatogram showing a rapid elution of a mixture of four analgesics on a sc-endcapped sc-C₁₈ column (100 mm×4.6 mm i.d, 3 m particles). Mobile phase used was AcN/KH₂PO₄ (25:75, v/v), with a flow rate of 2.00 ml/min. Ketoprofen, tᵣ=0.944 min.; naproxen, tᵣ=1.111 min.: 1.626 tᵣ=1.626 min.; ibuprofen=2.568 min.

FIG. 10 shows ²⁹Si NMR of Silica Hydride

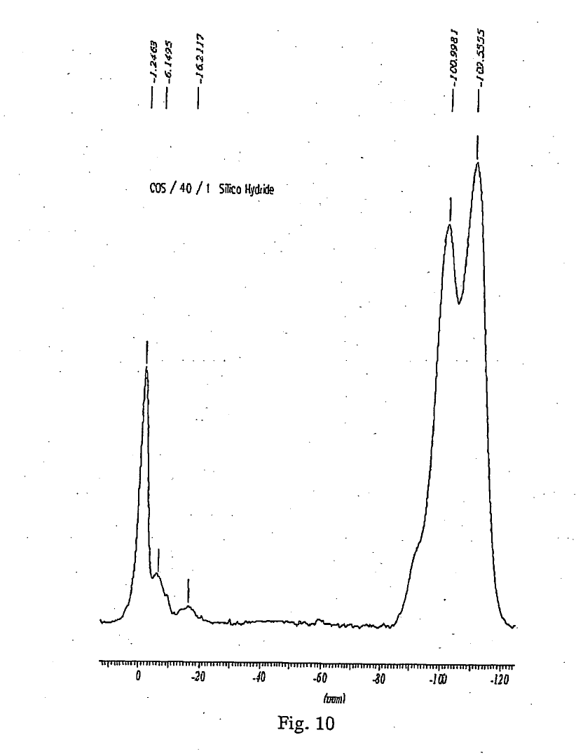

FIG. 11 shows ²⁹Si NMR of 3-mecaptopropyl silica

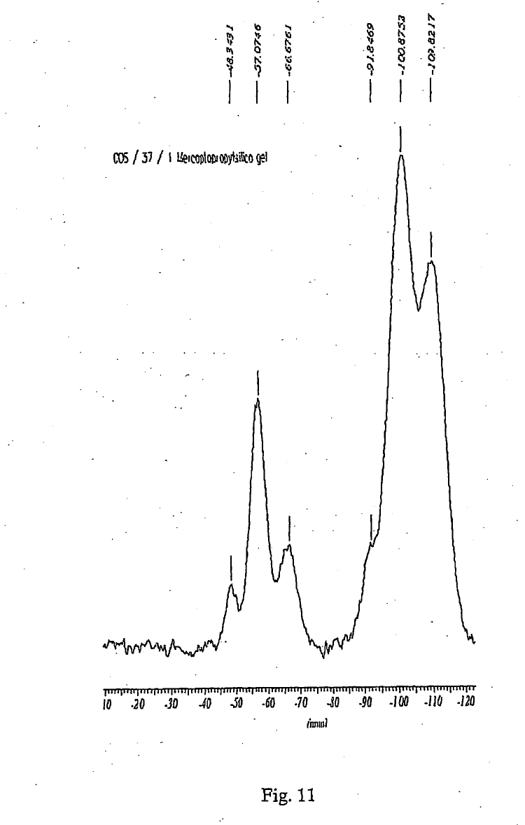

FIG. 12 is Chromatogram showing the elution of a racemic mixture of N-3,5-dinitrobenzoyl-phenylglycine on a non-encapped supercritical fluid generated chiral stationary phase, which employs tert-butyl carbamoylated quinine as the chiral template (100 mm×2.1 mm i.d., 3 μm particles). Mobile phase used was methanol-0.05M ammonium acetate buffer (v/v) adjusted to a pH, of 6.0 using acetic acid. Flow rate was 0.15 ml/min at ambient temperature and UV wavelength of 254 nm was chosen. The volume of injection was 10 μl. Samples were dissolved in methanol.

### DETAILED DESCRIPTION

The present invention provides a process for synthesising highly efficient chromatographic stationary phases in supercritical fluid, especially supercritical carbon dioxide (sc-CO₂). We have found that sc-CO₂ is a viable and highly desirable medium in the production of chromatographic phases especially bonded silica phases.

The term “supercritical” is taken throughout to mean that a fluid medium is at a temperature greater than its critical temperature and at a pressure greater than its critical pressure.

The relatively low critical temperature and pressure of carbon dioxide, its wide availability, low cost, low toxicity and reactivity, and non-flammable nature, make carbon dioxide the substance of choice. However many substances can be used as supercritical fluids, including supercritical carbon dioxide With modifiers (such as water, organic solvents including methanol, propanol, hexanol, acetonitrile, THF, DMSO), hydrocarbons (such as hexane, pentane, butane), haloalkanes (excellent solvents, ecofriendly such as fluoroform and 134a-Freon), and inert gases (xenon, helium, argon).

It has been estimated that over 60% of reversed phase separations are performed on chromatographic phases comprising ligands of straight chain C₈ and C₁₈ hydrocarbons especially C₁₈ hydrocarbons (8). There is a large market for efficient chromatographic phases which can be economically and efficiently produced.

Fluorinated ligands are known to be soluble in supercritical fluids, the fluorinated chain facilitating in the solubilisation; however it was also found in the present invention that non-fluorinated phases could also be readily prepared using sc-CO₂.

The use of sc-CO₂ as a reaction medium has considerable advantages over solvents conventionally used in the preparation of chromatographic phases.

It is a safer and more environmentally friendly solvent, in comparison to organic solvents such as toluene and dichloromethane, which are traditionally employed in synthesising chromatographic stationary phases. There is in addition no disposal problem of toxic organic solvents. The CO₂ can simply be vented for recycling.

The increased reaction kinetics also leads to faster reaction times. The supercritical process takes approximately 3 hours in comparison to the longer process times using conventional solvents or methods. This is economically very desirable.

The reaction of surface silanol groups with reactive organosilanes in the synthesis of chromatographic phases is the limiting step in that unreacted, residual silanol groups limit the chromatographic efficiency of final materials. The enhanced diffusivity and faster reaction rates in supercritical fluids such as sc-CO₂ allow greater access to reactive sites resulting in higher coverages and improved efficiencies with sc-CO₂ prepared bonded phase silicas.

In addition the sc-CO₂ process of the invention dries the silica, reacts it with a ligand and end-caps the phase, if needed, and removes or entraps, by complexation, metals from the silica surface, all in one chamber. The sc-bonded silica phases of the invention display a very high column efficiency even as non-endcapped phases.

After synthesis, the chromatographic phase does not have to undergo any complex filtration step and can be easily handled immediately after reaction, including using the supercritical fluid to deliver the phase to the support, such as in column packing or surface modification.

The present invention also provides a process for further treatment of bonded silicas by employing a chelating agent to sequester surface metals. Metals, in particular iron and alum inium are known to be detrimental to the chromatographic performance of silica-bonded phases. They cause adverse effects by two different means. Firstly, the metals provide sites that analytes can chelate to, thereby causing a mixed mode of retention. Secondly a metal atom makes the proximal hydroxyl group more acidic, thereby increasing unwanted interaction with basic compounds such as amines. By adding a metal sequestering reagent to the sc-CO₂ capable of removing so or surface complexation of these metals, the quality and properties, such as the hydrophobicity, of the chromatographic phase produced can be improved. The reagents may be utilised pre-process, in-process or post-process. Examples of metal sequestering agent used are perfluoro-octohydroxamic acid (PFOHA) or N-methylheptafluorobutyric hydroxamic acid (MHFBHA)

The solvating power of the supercritical fluid can be optimised for each chemical step in the production of chemically bonded silicas by varying temperature, pressure and time parameters.

The process using sc-CO₂ may be used in the delivery of, deposition of or reaction of ligands for the purpose of preparing and Locating a stationary phase in a micro-LC, CEC capillary or channel, or on-chip separation device. It may also be used in the derivatisation of a monolithic chromatographic phase, a sol gel, aerogel, xerogel, membrane, fibre or a surface, in addition to particle (micro-, meso- and nano-porous, non-porous, pellicular, bead), nanoshell and nanotube functionalisation.

The chromatographic phases of the invention may also be used for sample pre-treatment such as solid phase extraction in beds, membranes or surface film formats.

The invention will be more clearly understood by the following examples.

Chromatographic Characterisation of Bonded Phases

Testing a chromatographic phase by chromatographic means is advantageous. There is no requirement for equipment or expertise which is not already available in a chromatography laboratory. Such a test provides a means to assess a phase's relative strengths and weaknesses when eluting selected analytes under set conditions.

In 1991 Engelhardt et al formulated what is today one of the most widely-used chromatographic tests [53]. Through a series of elutions he found it possible to classify a column as “good” or “bad”, depending on its performance in his tests. The test has definite practical value in being able to speedily assess a columns properties and evaluate its strengths and weaknesses.

The test, like many other tests, has two distinct parts, one to assess hydrophobicity, one to assess silanol activity. The silanol activity test employs seven test probes—aniline, phenol, N,N-dimethylaniline (DMA), toluene and para-, ortho- and meta-toluidine. The mobile phase conditions are MeOH—H₂O (55:45, v/v). The test decrees that aniline should elute before phenol. The reasoning is that the basic aniline would be more susceptible to undesirable interaction with surface silanol groups. If it elutes before phenol—structurally very similar but not prone to silanol interaction—then the effects of silanol activity are minimal. This same reasoning also dictates that DMA should elute before toluene. Furthermore, any peak tailing observed for these solutes, corresponding to interaction with residual silanols, is undesirable. The ratio of peak asymmetries for aniline and phenol, should be smaller than 1.3. The isomeric toluidines only differ in their pKₐ values, not their hydrophobicities. Hence, a phase exhibiting very little silanol activity should not be able to separate these isomers.

The phases synthesised in the invention were characterised by solid state NMR spectroscopy and evaluated chromatographically using various solutes, including test probes. Practical pharmaceutical applications are also demonstrated.

### EXAMPLE 1

### Preparation of sc-Fluorinated CR Silica Phase

The reaction was performed using an ISCO model 260D syringe pump with an external stainless steel reaction cell (16×2 cm i.d.) with sapphire windows. 2.21 g of acid washed silica (3 μm Hypersil) was added, along with 0.359 ml of 1H, 1H, 2H, 2H-perfluorooctyl-triethoxysilane, and a magnetic stirrer bar. The cell was filled with 15 ml of CO₂, the temperature raised to 60° C. and the pressure to 450 atm. The stirrer plate was switched on, ensuring agitation of the silica in supercritical CO₂, and the reaction allowed to proceed for three hours. Through the cell window, the contents were visibly agitated due to the magnetic stirrer. The system was then cooled and depressurised, the modified silica recovered and analysed.

Elemental analysis yielded % C=5.54, % H=0.78. ¹³C and ²⁹Si CP/MAS solid state FOUR analysis was also carried out

### EXAMPLE 2

### Preparation of sc-C₁₈ Silica Phase

A C₁₈ phase was also synthesised using the same apparatus. 2.24 g of pre-treated silica (3 μm Hypersil) was added along with 0.387 g of n-octadecyl-triethoxysilane. This gives a theoretical loading of 25% carbon by weight. The cell was filled with 15 ml of CO₂, the temperature raised to 60° C. and the pressure to 450 atm. The stirrer plate was switched on, ensuring agitation of both the supercritical CO₂ and the silica. This can clearly be seen through the sapphire window. The reaction was allowed to proceed for three hours. The system was then cooled and depressurised, the modified silica recovered and analysed.

Elemental analysis yielded % C=20.58%, % H=1.44. ¹³C and ²⁹Si CP/MAS solid state NMR analysis was also performed.

### EXAMPLE 3

### Preparation of an sc-End-Capped sc-C₁₈ Silica Phase

A C₁₈ phase was prepared using the method as outlined in example 2. After the reaction was completed approximately 1.0 ml of hexamethyldisilazane was added. The reaction was further pressurised to 450 atm. at 60° C. for a further three hours, with agitation. The system was then cooled and de-pressurised and the modified silica recovered.

### EXAMPLE 4

### Preparation of Silica Hydride Phase, Dimethoxyhydridesilica

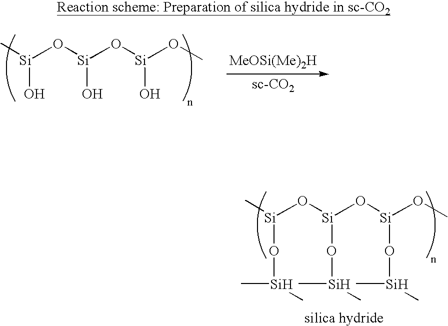

Silica gel (50.10 g) was dried at 70° C. for 12 hours and then placed in a 60 ml scf-reaction cell. Dimethylmethoxysilane (3.9 ml, ca. 25 mmol) was added. The suspension was stirred at 650 rpm and 70° C. under a CO₂ atmosphere of 6000 psi for 6.5 hours. Stirring was stopped for 20 min, the system dynamically extracted into 50:50 methanol: dilute HCl(aq) for 20 min and finally depressurised over 15 min. The silica hydride as a white powder was offloaded as 4.28 g, yielding on analysis by microanalysis found: C 1.82, H 0.72% w/w, N not detected (This is consistent with a loading of 0.76 mmol hydride/g SiO₂); NMR ¹³C CP-MAS NMR displayed resonance signals at 50.0 and −2.1 ppm, ²⁹Si CP-MAS NMR displayed resonance signals at −1.2, −6.1, −16.2, ca. −91 (shoulder), −101.0 and −109.6 ppm; Infrared DRIFT spectrum found absorbances at: 3659, 3327 (broad, OH stretch), 2968 (CH₂ stretch), 2910(CH₂, stretch), 2338 (atmospheric CO₂), 2145 (Si—H) cm⁻¹.

IR spectra clearly demonstrate the presence of the characteristic silane Si—H stretch ca 2145 cm⁻¹. ²⁹Si NMR analysis show characteristic resonances in the region of the spectrum between 0 and −20 ppm, in particular a strong absorbance at −1.2 ppm corresponds to the silica hydride produced by surface modification.

### EXAMPLE 5

### Preparation of Chiral Silica Bonded Phase

### Preparation of 3-mercaptopropylsilica Gel Using sc-CO₂

Silica gel (3.489 μg 3μ, Exsil, ex Alltech) auras placed in a 60 ml scf(supercritical fluid)-reaction cell. 3-mercaptopropyltrimethoxysilane (6.21 ml, 1.78 vol. 32.8 mmol) and pyridine (6.2 ml, 1.78 vol) were added. The suspension was stirred at 700 rpm under a CO₂ atmosphere at 70° C./5000 psi for 8.5 hours. Stirring was stopped for 30 min, the system dynamically extracted into 2N HCl (strong smell of pyridine) for 15 min and finally depressurised over 30 min. The silica product was suspended in EtOAc (ca. 200 ml), filtered, washed with EtOAc (2×20 ml), hexane (2×20 ml) and dried at 70° C. to constant weight over 3 hours. Mass recovered: 3.396 g (97.3% w/w) as a white powder.

Microanalysis found. C, 3.06; H, 0.74; S, 1.73% w/w, N not detected. DRIFT spectrum found absorbances at: 3647, 3517, 3445, 3295, 3173, 2938 (CH₂ stretch), 2852 (CH₂ stretch), 2579 (S—H stretch), 2338 (atmospheric CO₂), 1868, 1662 cm⁻¹. ¹³C CP-MAS NMR displayed resonance signals at 10.8, 27.0, 22.9 and 48.8 ppm. ²⁹Si CP-MAS NMR displayed resonance signals at 48.3, −57.1, −66.7, −91.8, −100.9 and −109.5 ppm.

Preparation of Quinine Derived Stationary Phase

3-mercaptopropyl silica gel (0.868 g, ca. 0.65 mmol thiol/g silica, est. 2.03 mmol thiol) was dried at 70° C. in air for 2 hours and further dried in a scf-reaction cell at 70° C./5000 psi CO₂ for 25 min. AIBN (0.108 g, 0.66 mmol, 0.3 eq) and t-butylcarbamoylquinine (0.868 g, 2.05 mmol, 1.01 eq) were added and the mixture stirred at 650 rpm under a CO₂ atmosphere at 70° C./4600-6000 psi for 41 hours.

Stirring was stopped and the contents allowed settle for 20 min, the system dynamically extracted at ca. 2-5 ml/min into a MeOH solution for 40 min. Stirring was repeated for 20 min, then stopped and the contents allowed to settle for 20 min. The system was dynamically extracted at ca. 2-5 ml/min into a MeOH solution for 40 min, and finally depressurised over 15 min to give 3.129 g of product as a beige powder. A sample (ca 2.900 g) was triturated overnight in CHCl₃ (ca. 10 ml). The cloudy suspension was filtered and die bed washed with fresh chloroform (1×10 ml, 1×5 ml). The bed was further dried on the pump for 1 hour and in air at 70° C. for 1 hour to give 2.645 g of off-white powder.

Microanalysis found: C, 11.07; H, 1.54; S, 0.84; N, 1.08% w/w. This represents an increase from the input 3-mercaptopropylsilica of 7.82% w/w carbon; 0.63% w/v hydrogen; and 1.08% w/w nitrogen.

DRIFT spectral analysis found absorbances at: 3660 (amide N—H stretch), 2932 (C—H stretch), 2339 (atmospheric CO₂), 1863, 1724 (C═O stretch), 1510, 1455, 1076, 811 cm⁻¹.

sc-Fluorinated C₈ Silica Phase—²⁹Si Solid State NMR

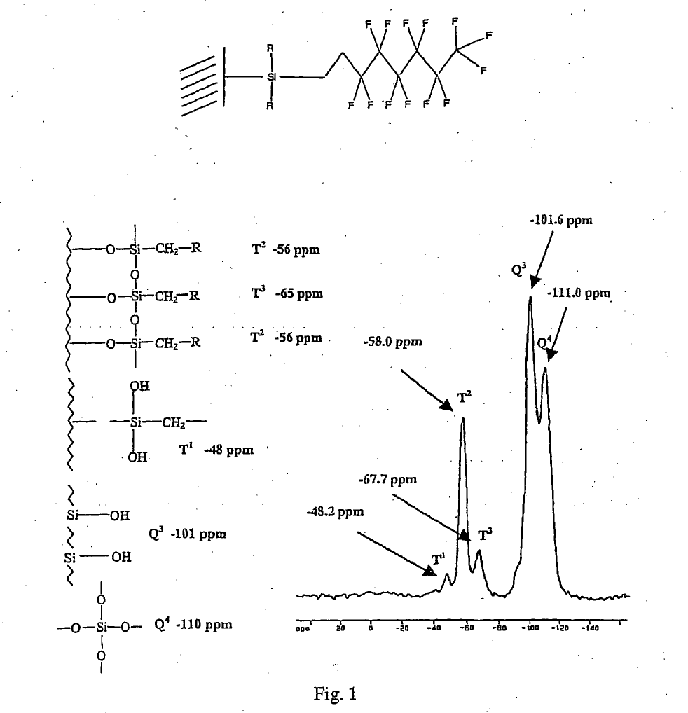

FIG. 1 shows the ²⁹Si solid state NMR spectra with assigned resonances for the bonded phase chemical species (T₁ to T₃ and the underivatised silanol groups (Q³ and Q⁴).

sc-Fluorinated C₈ Silica Phase—¹³C Solid State NMR

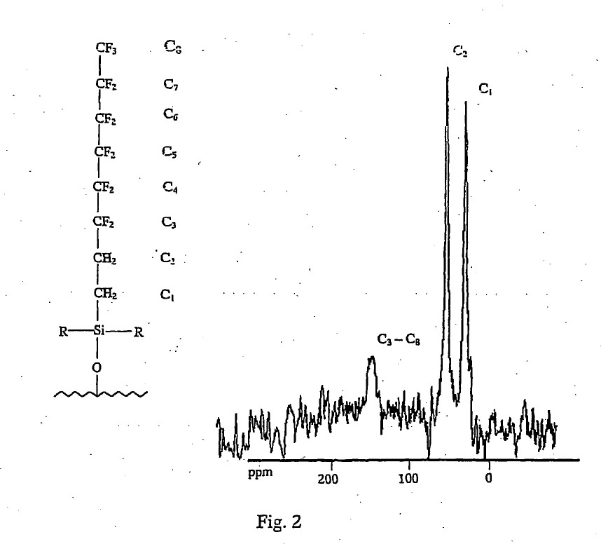

The fluorinated carbons (C₃ to C₈) do not give strong resonances. Two distinct signals assigned to the two hydrogen-bearing carbons are shown in FIG. 2, confirming surface bonding.

²⁹Si Solid State NMR of sc-C₁₈ Silica Phase

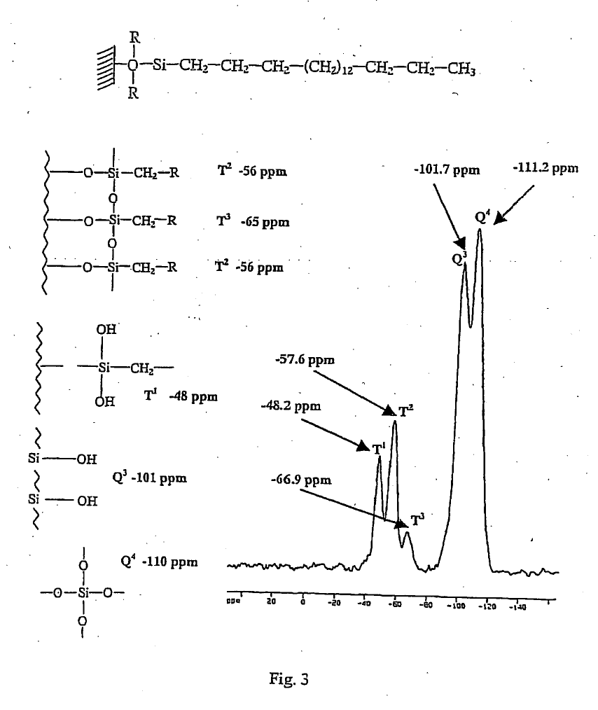

The solid state ²⁹Si NMR spectrum for the sc-C₁₈ is silica phase is shown in FIG. 3. The two large peaks at −110 and −111 ppm correspond to underivatised silica. Once again, the three resonances (T¹, T² and T³), confirm the presence of surface bonded species and successful bonding.

¹³C CP/MAS Solid State NMR of sc-C₁₈ Silica Phase

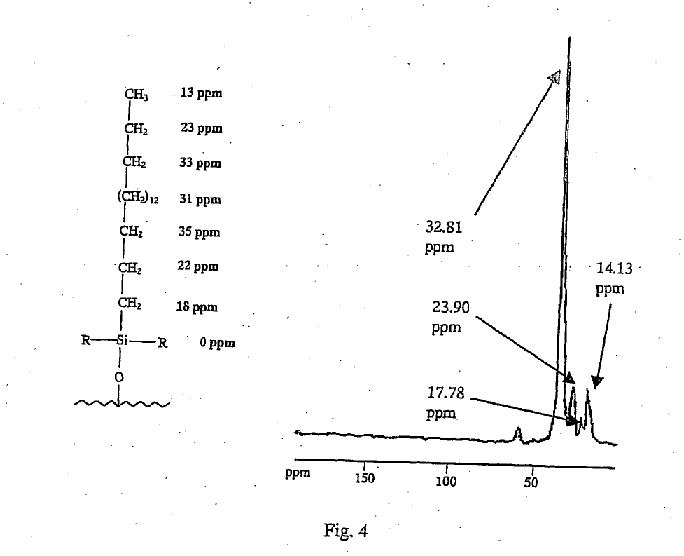

The large resonance peak at 32.5 ppm corresponds to the bulk of the carbon atoms in the bonded hydrocarbon chain (FIG. 4). Expected resonances are shown on the left and are in good agreement with the values determined experimentally.

Column Packing

The sc-fluorinated C₈ phase was packed in house at 6,000 psi on a Shandon column packer (Shandon, United Kingdom). Isopropyl alcohol (H-LC grade, Merck, Darmstadt) was used as a packing solvent and 50:50 methanol/water used as a conditioning solvent. All chromatography columns were made of stainless steel, were of length 150 mm and internal diameter 4.6 mm, obtained from Jones Chromatography (Glamorgan, UK). The sc-C₁₈ silica phase was packed to the standard of commercial phases (including higher pressures).

Chromatographic Evaluation

sc-Flourinated C₈ Silica Phase

The fluorinated C₈ phase was assessed by eluting a reversed phase test mix solution containing benzamide, benzophenone and biphenyl and was eluted using a 50:50 acetonitrile/water mobile phase. The results of the test mix separation are shown in

TABLE 1

| | Retention | Capacity | |
|---|---|---|---|
| Solute | Time (min.) | Factor (k′) | Selectivity (α) |
| Benzamide | 2.43 | 1.03 | benza/benzoph 7.87 |
| Benzophenone | 10.93 | 8.11 | benzoph/biph 1.84 |
| Biphenyl | 19.10 | 14.92 | benza/biph 14.49 |

sc-Prepared C₁₈ Phases

Fluorinated organosilanes were chosen as the ligand initially as they were expected to be very soluble in supercritical CO₂. In addition reactions using silica and non-fluorinated organosilanes in sc-CO₂ yielded silica bonded phases.

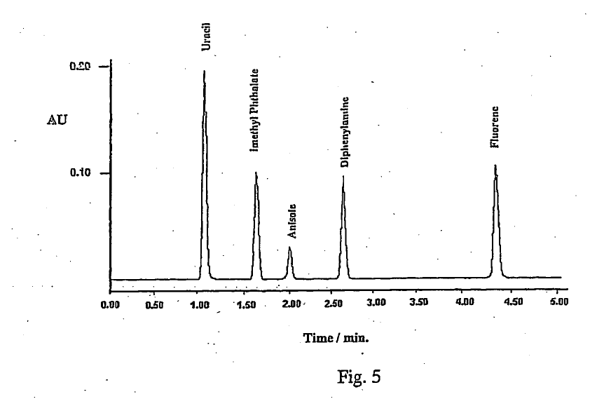

For example n-octadecyltriethoxysilane was reacted under supercritical fluid conditions with acid-washed silica as described and packed into a stainless steel column (150 mm×4.6 mm i.d.). FIG. 5 shows a chromatogram of a test mix elution on this non-endcapped sc-C₁₈ column.

Table 2 gives the calculations (Efficiency (N) and peak asymmetry factors) for the test-mix elution on a non-endcapped sc-C₁₈ column.

TABLE 2

| | | | Efficiency (N) | | Capacity |
|---|---|---|---|---|---|
| | | | Half Height | Asym | Factor |
| | Name | t_{R} | (per meter) | @ 10% | (k′) |
| 1 | Uracil | 1.06 | 31,684 | 1.15 | 0 |
| 2 | Dimethyl | 1.63 | 63,677 | 1.13 | 0.53 |
| | Phthalate | | | | |
| 3 | Anisole | 2.00 | 82,359 | 1.04 | 0.89 |
| 4 | Diphenylamine | 2.61 | 107,558 | 1.10 | 1.46 |
| 5 | Fluorene | 4.32 | 141,424 | 1.06 | 3.07 |

The plate numbers (N) and asymmetry factors are surprisingly high considering that the phase has not been end-capped. In fact, this phase passes standards set by commercial manufacturers who expect plate numbers in excess of 100,000 for a column of this length and asymmetry factors between 0.9 and 1.2.

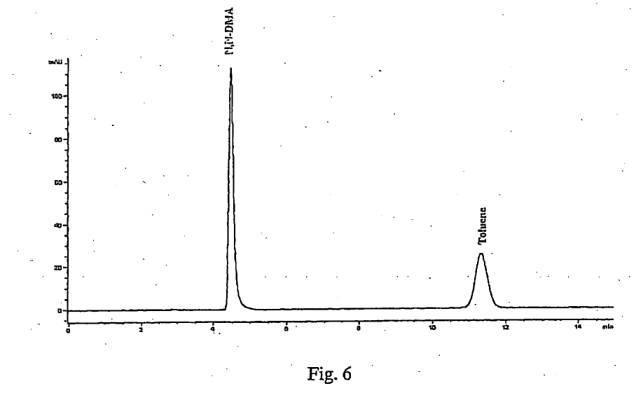

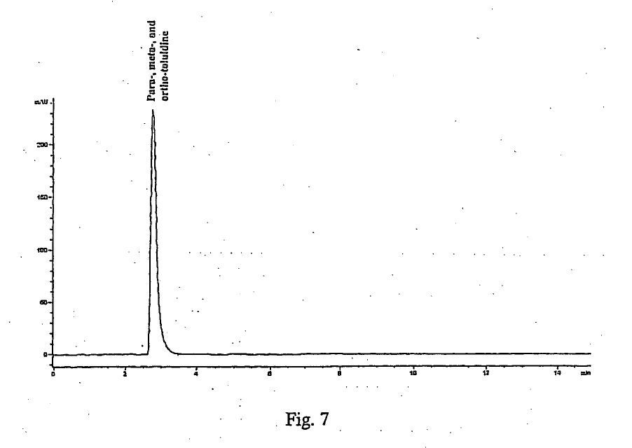

Other examples including octadecyldimethyltrichlorosilane and octadecyldimethylmethoxysilane were successfully immobilised onto 3μ silica and the resultant phases, when packed, gave plate numbers of 105,781 and 100,991 for fluorene under the same conditions as outlined above. Another sc-C₁₈ silica phase was prepared and end-capped using hexamethyldisilazane in sc-CO₂. When this column was subjected to the Engelhardt test, N,N-DMA eluted before toluene. Also, the isomers of toluidine eluted as a single peak, indicating low silanol activity. (FIGS. 6 and 7).

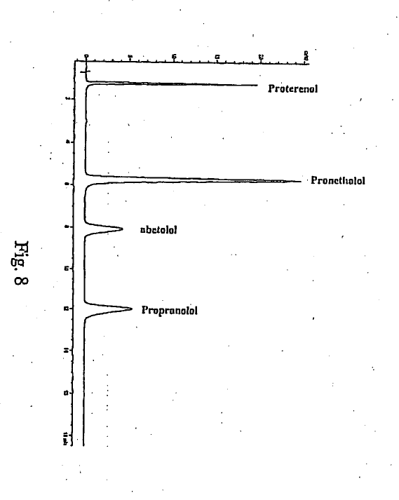

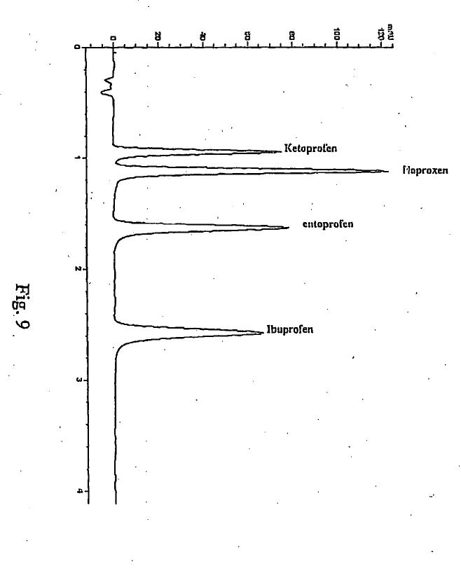

Pharmaceutical applications were also tested on the sc- end-capped sc-C₁₈ column. The column was successfully able to resolve a mix of six β-blockers and a mixture of analgesics as shown in FIGS. 8 and 9.

Non-Encapped Supercritical Fluid Generated Chiral Stationary Phase

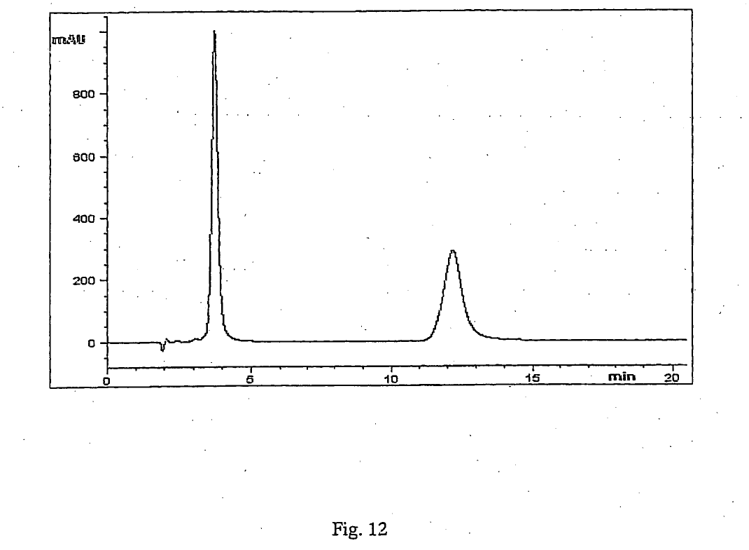

Chiral separation of a racemic mixture of N-3,5-dinitrobenzoyl-phenylglycine on a non-encapped supercritical fluid generated chiral stationary phase, which employs tert-butyl carbamoylated quinine as the chiral template (100 mm×2.1 mm i.d., 3 μm particles) was achieved (FIG. 12).

The chromatographic phases produced by the process of the invention have a number of important and unique characteristics as follows:
Higher stationary phase loading due to the enhanced diffusivity of solutes in supercritical carbon dioxide, rendering accessible certain silanols occluded in organic solvents. For example, in the preparation of the silica hydride phase, extended reaction times results in increased loading for example, 22 hours under supercritical fluid conditions resulted in a loading of 0.96 mmol/g compared to 0.64 mmol of hydride per g SiO2 was achieved in refluxing toluene over 24 hours.
The benefit also exists from using supercritical fluid as a drying agent, removing water to produce a more homogenous surface-bonded phase.
Reaction in supercritical fluid can produce different additional chemically bonded species than in organic solvents i.e. surface bound species. For example 13 C nmr analysis of selected phases, shows resonances consistent with the alkoxysilane undergoing an addition reaction to a surface siloxane rather than a displacement reaction with a surface silanol, yielding Si—OMe surface species.
The use of a chelating agent in a step to complex surface metals makes the phases characteristically different in their surface metal content or by the inactivation of this metal content by in-situ complexation. In the latter, chelating agent will be present at the surface, playing the dual role of metal complexation and providing hydrophobic side chains for chromatography. In this case, the phase is seen to be off-white or cream in colour as opposed to white.

The invention is not limited to the embodiments hereinbefore described which may be varied in construction and detail.

### REFERENCES

1. J. Nawrocki. J. Chromatogr. A: 779 (1997) 29.
2. L. T. Zhuravlez, Colloids and Surfaces, 173 (2000) 1.
3. C. Stella, S. Rudaz, J. L. Veuthey, A. Tchapla, Chromatographia, 53 (2001) 113.
4. A. Braithwaite, M. Cooper, Chromatographia, 42 (1996) 77.
5. B. R. Edwards, A. P. Giauque, J. D. Lamb, J. Chromatogr. A 706 (1995) 69.
6. A. Karlsson, O. Karlsson, J. Chromatogr. A, 905 (2001) 329.
7. R. P. W. Scott, Silica Gel and Bonded Phases, published by John Wiley & Sons Ltd. West Sussex, England.
8. M. Pursch, R. Brindle, A. Ellwanger, L. C. Sander, C. M. Bell, H. Handel, K. Albert, Solid State Nuclear Magnetic Resonance, 9 (1997) 191.
9. V. Schurig, J. Chromatogr. A, 906 (2001) 275.
10. B. Koppenhoefer, X. Zhu, A. Jakob, S. Wuerthner, B. Lin, J. Chromatogr. A, 875 (2000) 135.
11. E. Schneiderman, A. M. Stalcup, J. Chromatogr. A, 745 (2000) 83.
12. S. Svensson, J. Vessman, A. Karlsson, J. Chromatogr. A, 839 (1999) 23.
13. J. D. Glennon, E. Horne, K. Hall, D. Cocker, A. Kuhn, S. J. Harris, M. A. McKervey, J. Chromatogr. A, 731, (1996), 47.
14. J. S. Millership, M. A. McKervey, J. A. Russell, Chromatographia, 48, (1998), 402.
15. P. Mnuk, L. Feltl, V. Schurig, J. Chromatogr. A, 732, (1996), 63-74.
16. D. W. Armstrong, M. P. Gasper and K. L. Rundlett, J. Chromatogr. A, 689, (1995), 285.
17. J. Blümel, J. Am. Chem. Soc., 117 (1995) 2112.
18. C. P. Tripp, M. L. Hair, Langmuir, 8 (1992) 1961
19. M. L. Hair, C. P. Tripp, Colloids and Surfaces, 105 (1995) 95.
20. C. P. Tripp, M. L. Hair, Langmuir, 7 (1991) 923.
21. C. P. Tripp, M. L. Hair, Langmuir, 8 (1992) 1120.
22. J. Sagiv, J. Am. Chem. Soc., 102 (1980) 92.
23. J. J. Pesek, M. T. Matyska, X. Pan, J. Chromatogr. A, 992 (2003) 57
24. Pesek et al, Anal. Chem., 65 (1993) 808
25. Pesek et al, J. Chromatogr. A, 947 (2002) 195
26. M. Montes, C. van Amen, J. J. Pesek, J. E. Sandoval, J. Chromatogr. A, 688 (1904) 31
27. J. J. Pesek, M. T. Matyska, M. Oliva, M. Evanchic, J. Chromatogr. A, 818 (1998) 145.
28. J. J. Pesek, M. T. Matyska, V. Grandhi, J Separation Science, 25 (2002) 741
29. R. Valentine; PhD Thesis; 2002;
http://etd.library.pitt.edu/ETD/available/etd-03272002-170144/unrestricted/RValentine2002.pdf
30. G. Uccello-Barretta, F. Mirabella, F. Balzano, P. Salvadori, Tetrahedron: Asymmetry, 14 (2003) 1511
31. P. Salvadori, C. Rosini, D. Pini, C. Bertucci, P. Altemura, G. Uccello-Barretta A. Raffaelli, Tetrahedron, 43 (1987) 4969
32. C. Pettersson, C. Gioeli, J. Chromatogr. A, 435 (1988) 225
33. http://www.chromaphor.de/chir_fly.pdf & http://www.chromapbor.de/chir_lit.pdf
34. N. M. Maier, S. Schefzick, G. M. Lombardo, M. Feliz, K. Rissanen, W. Lindner, K. B. Lipkowitz; J. Am. Chem. Soc., 124 (2002) 8611
35. W. R. Oberleitner, N. M. Maier, W. Lindner, J. Chromatogr. A, 960 (2002) 97
36. W. Lindner, A. Mandl, L. Nicoletti, M. Lammerhofer; J. Chromatogr. A, 858 (1999) 1
37. Gasparrini et al, J. Chromatogr. A, 906 (2001) 35
38. P. Franco, M. Lammerhofer, P. M. Klaus, W. Lindner, J. Chromatogr. A, 869 (2000) 111
39. B Wheals, J. Chromatogr. A, 117 (1979) 263
40. A. Tambuté, P. Macaudiére, M. Lienne, M. Caude, R. Rosset, J. Chromatogr. A, 467 (1989) 357
41. E. Veigl, W. Lindner; J. Chromatogr. A, 660 (1994) 255
42. C Rosini, C. Bertucci, D. Pini, P. Altemura. P. Salvadori. Tetrahedron Letters, 26 (1985) 3361
43. C. Rosini, P. Altemura, D. Pini, C. Bertucci, G. Zullino, P. Salvadori, J. Chromatogr. A, 348 (1985) 79
44. W. H. Pirkle, D. W. House, J. Org. Chem., 44 (1979) 1957
45. Scholten, A. B.; Claessens, H. A.; de Haan, J. W.; Cramers, C. A. J. Chromatogr., A 1997, 759, 37.
46. Buszewski, B.; Schimd, J.; Albert, IC; Bayer, E. J. Chromatogr., A 1991, 552, 415.
47. McCalley, D. V.; Brereton, R. G. J. Chromatogr., A 1998, 828, 407.
48. Yarita, T.; Nomura, A.; Horimoto, Y. J. Chromatogr., A 1996, 724, 373.
49. Combes, J. R.; White, L. D.; Tripp, C. P. Langmuir 1999, 15, 7870.
50. U.S. Pat. No. 5,725,987 in the name of Xerox Corporation
51. U.S. Pat. No. 5,714,299 in the name of Xerox Corporation
52. Shin, Y.; Zemaniam, T. S.; Fryxell, G. E.; Wang, L. Q.; Liu, J. Microporous and Mesoporous Materials 2000, 37, 49.
53. H. Engelhardt, H. Low, W. Götzinger, J. Chromatogr. A, 544 (1991) 371.

1-39. (canceled)

40. A process for the synthesis, delivery or deposition or localisation of a chromatographic phase, especially for chromatographic separation or solid phase extraction, comprising introducing a chemical moiety to a support using a supercritical fluid.

41. The process as claimed in claim 40 wherein the support is a porous solid metal oxide.

42. The process as claimed in claim 41 wherein the porous solid metal oxide is nanoporous, mesoporous, microporous or macroporous.

43. The process as claimed in claim 40 wherein the support is in the form of a particle (porous and non-porous), sol-gel, monolith, aerogel, xerogel, membrane, fibre, or a surface, such as of a capillary or nanoshell or nanotube or micro/nano channel or microfabricated column on-chip.

44. The process as claimed in claim 41 wherein the metal oxide is selected from any one or more of silica, alumina, titania or a functionalised metal oxide such as aminopropylsilica or hydride silica.

45. The process as claimed in claim 40 wherein a reactive form of the chemical moiety is delivered to the support by the supercritical fluid.

46. The process as claimed in claim 40 wherein the chemical moiety is deposited onto the support phase.

47. The process as claimed in claim 40 wherein the chemical moiety is soluble in the supercritical fluid.

48. The process as claimed in any claim 40 wherein the chemical moiety is a reactive organosilane such as an alkoxy derivative, a halogenated derivative or hydrosilane.

49. The process as claimed in claim 48 wherein the chemical moiety is selected from any one or more of dimethylmethoxyoctadecylsilane or trichloro-octylsilane.

50. The process as claimed in claim 40 wherein the chemical moiety is selected from any one or more of n-octadecyltriethoxysilane, n-octadecyl-dimethyl-monomethoxysilane, 1H,1H,2H,2H-perfluorooctyltriethoxysilane,
Hexamethyldisilazane, trimethylchlorosilane, or reagents such as alkene derivatives and alkyne derivatives for the process of hydrosilation with a silica hydride.

51. The process as claimed in claim 40 wherein the chemical moiety is octadecyldimethylchlorosilane or octadecyldimethylmethoxysilane.

52. The process as claimed in claim 40 wherein attachment or deposition of the chemical moiety to the support yields a hydrocarbon chromatographic phase, a fluorinated hydrocarbon chromatographic phase, a perfluorinated chromatographic phase, a reversed phase chromatographic phase, a normal phase chromatographic phase, an ion exchange chromatographic phase, an affinity chromatographic phase, a chiral chromatographic phase, a chelating phase, a macrocyclic phase (such as a calixarene phase) or a silica hydride phase.

53. The process as claimed in claim 52 wherein the hydrocarbon phase is a C8 or C18 phase.

54. The process as claimed in claim 40 wherein the supercritical fluid is supercritical carbon dioxide.

55. The process as claimed in claim 40 wherein the reaction is carried at a temperature of from 31.3° C. to 600° C.

56. The process as claimed in claim 55 wherein the reaction is carried at a temperature of from 40° C. to 80° C.

57. The process as claimed in claim 40 wherein the reaction is carried out at a pressure of from 1,058 psi to 30,000 psi.

58. The process as claimed in claim 57 wherein the reaction is carried out at a pressure of from 1,200 psi to 8,000 psi.

59. The process as claimed in claim 40 wherein the reaction is carried out for a period of up to 100 hours.

60. The process as claimed in claim 59 wherein the reaction is carried out for approximately 3 hours.

61. The process as claimed in claim 40 including a drying step using a supercritical fluid.

62. The process as claimed in claim 40 including a chelating agent.

63. The process as claimed in claim 62 wherein the chelating agent is a metal sequestering agent.

64. The process as claimed in claim 62 wherein the chelating agent is a fluorinated or non-fluorionated hydroxamic acid.

65. The process as claimed in claim 63 wherein the metal sequestering agent is perfluorooctylhydroxamic acid (PFOHA) or N-methylheptafluorobutyric hydroxamic acid (MHFBHA).

66. A process for synthesising a chromatographic phase comprising the steps of;
adding a support and a chemical moiety to a reaction vessel;
delivering a reaction medium to the reaction vessel;
raising the temperature of the reaction vessel to a temperature of between 31.2° C. to 600° C. at a pressure of between 1,058 psi to 30,000 psi to form a supercritical fluid;
agitating the contents of the reaction vessel for approximately 3 hours; and
recovering the chromatographic phase.

67. The process as claimed in claim 66 including the step of modifying the chromatographic phase using a chelating agent, pre-, in-, or post-process.

68. The process as claimed in claim 40 wherein the reaction is carried out in a single chamber.

69. A process for the synthesis of a chromatographic phase comprising introducing a chemical moiety to a support in the presence of a supercritical solvent and a chelating agent.

70. The process as claimed in claim 69 wherein the chelating agent is a metal sequestering agent such as a fluorinated or non-fluorinated hydroxamic acid.

71. The process as claimed in claim 70 wherein the metal sequestering agent is perfluoro-octylhydroxamic acid (PFOHA) or N-methylheptafluorobutyric hydroxamic acid (MHFBHA)

72. The chromatographic phase whenever prepared by a process as claimed in claim 40.

73. The bonded silica phases for chromatographic or solid phase extraction purposes whenever prepared by a process as claimed in claim 40.

74. A chromatographic stationary phase having Si—OMe surface species.

75. A chromatographic stationary phase having a chelating agent on the surface thereof.

76. The chromatographic column containing a stationary phase as claimed in claim 72.

77. Use of supercritical fluid in the preparation of a chromatographic phase such as a bonded silica phase.
